(19) United States
(12) Patent Application Publication
(10) Pub. No.: US 2013/0067045 A1
(43) Pub. Date: Mar. 14, 2013

(54) INTERSYSTEM COORDINATION APPARATUS IN DISTRIBUTION SYSTEM

(71) Applicants: Kenichiro KAWAKAMI, Yamato (JP); Hiromitsu KATO, Yokohama (JP); Toshihiko NAKANO, Tokai (JP); Hidenori YAMAMOTO, Yokohama (JP); Masatoshi MURAKAMI, Yokohama (JP); Takaaki HARUNA, Kawasaki (JP)

(72) Inventors: Kenichiro KAWAKAMI, Yamato (JP); Hiromitsu KATO, Yokohama (JP); Toshihiko NAKANO, Tokai (JP); Hidenori YAMAMOTO, Yokohama (JP); Masatoshi MURAKAMI, Yokohama (JP); Takaaki HARUNA, Kawasaki (JP)

(73) Assignee: HITACHI, LTD., Tokyo (JP)

(21) Appl. No.: 13/547,385

(22) Filed: Jul. 12, 2012

(30) Foreign Application Priority Data
Sep. 13, 2011 (JP) 2011-199205

(51) Int. Cl. G06F 15/177

(52) U.S. Cl. 709/220

(57) ABSTRACT

The intersystem coordination apparatus includes: a storage unit configured to store a pattern of a communication protocol between the system and the other system, a protocol definition in which system configurations of these systems and network configurations, a non-functioning requirement which is a unique requirement of a predetermined application for the system to access the other system by using the predetermined application, and a plurality of modules configured to execute the application in accordance with the protocol definition and the non-functioning requirement; an application processing unit configured to execute the predetermined application; and a combination processing unit configured to select a module required to execute processing by the application from the plurality of modules based on the non-functioning requirement and a requirement value required to perform processing between these systems determined based on the communication protocol pattern, the system configuration, and the network configuration included in the protocol definition.

### CLAIM OF PRIORITY

The present application claims priority from Japanese application serial no. JP2011-199205, filed on Sep. 13, 2011, the content of which is hereby incorporated by reference into this application.

### FIELD OF THE INVENTION

The present invention relates to an intersystem coordination apparatus among a plurality of distribution systems connected through, for example, a network.

### BACKGROUND OF THE INVENTION

In a power field system and the like, the expansion of a control monitoring target, the expansion of a data use range, coordination among different systems, coordination among different businesses, and the like are progressing due to diversification of power, the expansion of energy management of a district zone, a home, and the like. Meanwhile, in foreign countries, movements in response have been expanded by consolidating international standards such as a system method, an application interface, a data model, and the like and while the International Electrotechnical Commission (IEC) has progressed to consolidate individual standards. However, as the standards are basically consolidated for each field, each business type, or each layer, the development of an application that follows a plurality of standards may be required in many cases, in particular, in the case of presupposing the coordination among different systems, the coordination among different businesses, and the like. A vender that participates in system development usually performed system development in accordance with individual methods in respect to fields, business types, and the like where the standard is not consolidated and in this case, development of an application that follows a plurality of different methods rather than the standards is required.

In response to the development of the application through the plurality of different methods, for example, WO publication No. 2006/114810, proposes a method of performing data conversion by means of a communication driver performing communication between a management device and a facility device when data formats in both devices are different from each other, describing an attribute, a function object, and the like of the facility with a markup language, and converting the described attribute and function object by using functional class information and configuration information for each facility, respectively.

Japanese Patent Application Laid-open No. Hei 11(1999)-353168 proposes a method of absorbing a difference in sequences of a method and a parameter from each interface description, extracting a correspondence relationship of the method and the parameter, and automatically creating a code to install a client-side interface by aggregating reuse components when one or more software components having different interfaces are reused.

Japanese Patent Application Laid-open No. 2010-67181 proposes a method of placing an intersystem coordination apparatus for each system, the intersystem coordination apparatus's transmitting data transmitted by a communication protocol to other systems, extracting common data and data required to the self-system from received data by using the received intersystem coordination apparatus, and transmitting the extracted data into the self-system by using the communication protocol of the self-system again.

### SUMMARY OF THE INVENTION

However, in the techniques disclosed in Japanese Patent Application Laid-open Nos. 2007-514335, Hei 11(1999)-353168, and 2010-67181, only one of the data model, the interface, and the communication protocol is converted when the systems are interconnected. As a result, when two or more of the data model, the interface, and the protocol are different from each other, the data model, the interface, and the protocol cannot correspond to each other and a failure may occur while connection. All processing for conversion and connection needs to be prepared individually in two different systems that are interconnected with each other and when the number of access points and the number of corresponding standards increase, a load to prepare the processing increases.

Processing for satisfying non-functioning requirements which are requirements required by the individual applications needs to be prepared at each application side. As a result, a renovation load of an application depending on addition and change of the access points increases. In Japanese Patent Application Laid-open No. 2010-67181, a fixed procedure is just implemented on a fixed communication protocol for coordination by the intersystem coordination apparatus. Therefore, when a type of the procedure depending on execution of the interface and a type of the communication protocol used as an access point system are different from each other, the connection and the procedure cannot be performed.

As such, under an environment in which a plurality of systems based on different standards or methods are mixedly operated, processing for connecting and coordinating individual different systems needs to be developed for each connection and coordination, apart from individual original application processing itself. As the mixedly operated different systems increase, intersystem connection and coordination processing which needs to be developed increases, and simultaneously, the processing itself also becomes complicated and a labor or man-hour of the development increases. Since the connection and coordination processing needs to be developed after determining details of a standard or a method of a system which is a connection and coordination target, the burden of an application developer increases.

The present invention has been made in an effort to provide an intersystem coordination device in a distribution system that can perform processing for interconnection to middleware which is not perceived by the application developer (interconversion between the standard and the method) and processing for satisfying non-functioning requirements required while actual connection and coordination, easily develop individual connection and coordination processing as a middleware function, and improve productivity of application development, after excluding preparation as application processing, in the case where a plurality of different systems are interconnected and intercoordinated based on different standards or methods.

An embodiment of the present invention provides an intersystem coordination apparatus, in a distribution system capable of accessing, from a system prepared based on a predetermined standard or method, another system prepared based on a standard or a method different from the system, the apparatus including: a storage unit configured to store a pattern of a communication protocol between the system and the other system, a protocol definition in which system configurations of the system and the other system and network configurations correspond to each other, a non-functioning requirement which is a unique requirement of a predetermined application for the system to access the other system by using the predetermined application, and a plurality of modules for executing the application in accordance with the protocol definition and the non-functioning requirement; an application processing configured to execute the predetermined application by accessing the other system; and a combination processing unit configured to select a module required to execute processing by the application from the plurality of modules based on the non-functioning requirement and a requirement value required to perform processing between the system and the other system determined based on the communication protocol pattern, the system configuration, and the network configuration included in the protocol definition in accordance with a request from the predetermined application, in the case where the application processing unit receives an instruction to execute the predetermined application.

According to the present invention, an intersystem coordination apparatus can be provided in a distribution system capable of improving productivity of application development.

### BRIEF DESCRIPTION OF THE DRAWINGS

FIG. 1 is a diagram illustrating a configuration example of a distribution system in a first embodiment;

FIG. 2 is a diagram illustrating an example of externally defined items (external definition of a data model, external definition of an interface, and external definition of a protocol);

FIG. 3 is a schematic diagram illustrating a request/replay procedure pattern in the first embodiment;

FIG. 4 is a schematic diagram illustrating a publish/subscribe procedure pattern in the first embodiment;

FIG. 5 is a schematic diagram illustrating a unidirectional procedure pattern in the first embodiment;

FIG. 6 is a flowchart illustrating a sequence of an intersystem coordination method in the first embodiment;

FIG. 7 is a flowchart illustrating a processing sequence of combination processing performed by a combination processing unit;

FIGS. 8A-8G are a diagram illustrating an operational overview of each processing module in the first embodiment;

FIG. 9 is a diagram illustrating a configuration example of a distribution system in a second embodiment; and

FIG. 10 is a diagram illustrating a configuration example of a distribution system in a third embodiment.

### DETAILED DESCRIPTION OF THE EMBODIMENTS

Hereinafter, an embodiment of an intersystem coordination apparatus in a distribution system according to the present invention will be described in detail with reference to the accompanying drawings.

### First Embodiment

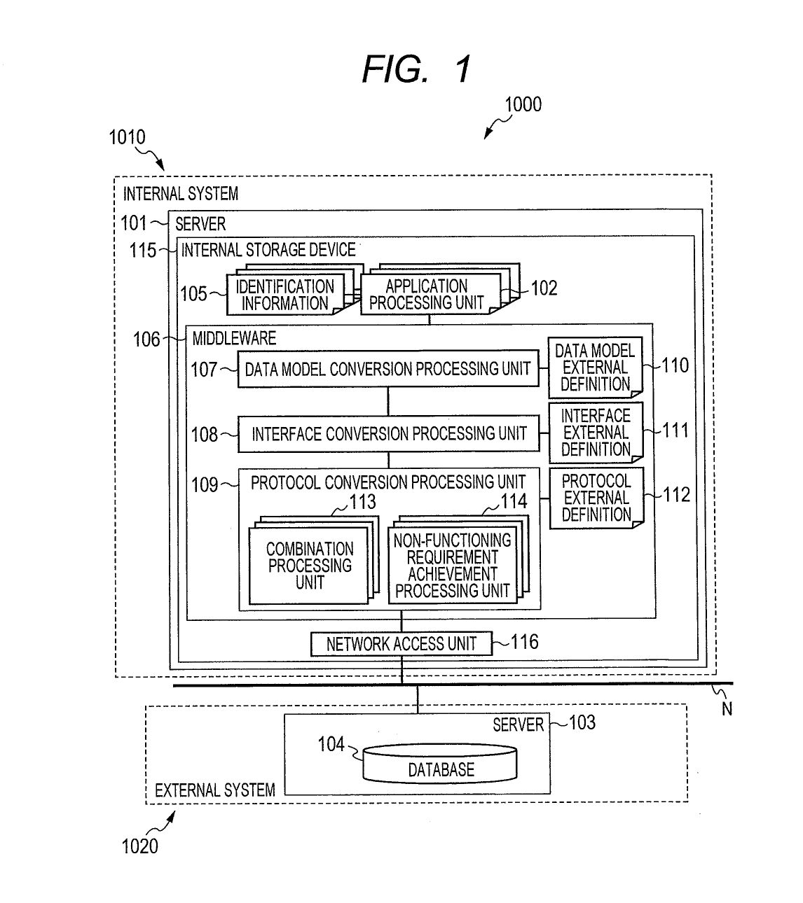

FIG. 1 is a diagram illustrating a configuration example of a distribution system 1000 in a first embodiment. As illustrated in FIG. 1, the distribution system 1000 includes an internal system 1010 and an external system 1020. The internal system 1010 and the external system 1020 are connected with each other by a general network N such as the Internet and the like.

The internal system 1010 is a system different from the external system 1020 having a predetermined application used by a user and is inserted into an internal storage device 115 of a server 101 (an intersystem coordination apparatus). The internal storage device 115 stores application processing units 102 that execute a plurality of applications used by a user who can access the internal system 1010 and identification information 105 for only identifying the application processing units 102, which correspond to each other.

Middleware 106 is stored in the internal storage device 115. The middleware 106 includes a data model conversion processing unit 107, an interface conversion processing unit 108, and a protocol conversion processing unit 109.

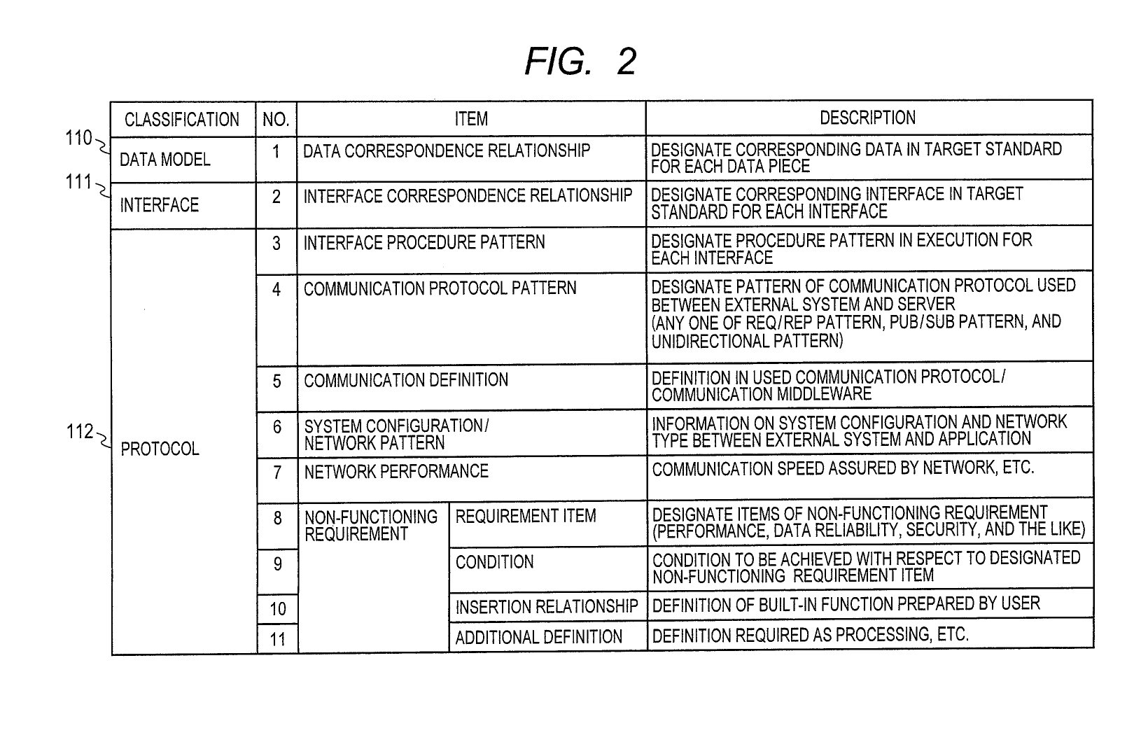

The data model conversion processing unit 107 puts common meaning to data shared by both the internal system 1010 and the external system 1020 (for example, all data used in each system is made into a data model according to a common information model (CIM)) and converts a data model used in the internal system 1010 into a data model used in the external system 1020. As illustrated in FIG. 1, the data model conversion processing unit 107 may access a data model external definition 110. The data model external definition 110 is information configured to define various correspondences associated with a data model for performing conversion with the data model of the external system 1020 and will be described below by using FIG. 2.

The interface conversion processing unit 108 determines a designation method of processing requested by the application 102 of the internal system 1010 (for example, an interface used in the internal system 1010 is set as an open-standard interface used in the external system 1020) and converts the interface used in the internal system 1010 into the interface used in the external system 1020 similarly as the data model conversion processing unit 107. As illustrated in FIG. 1, the interface conversion processing unit 108 may access an interface external definition 111. The interface external definition 111 is information configured to define various correspondences associated with an interface for performing conversion with the interface of the external system 1020 similarly as the data model external definition 110 and will be described below by using FIG. 2.

The protocol conversion processing unit 109 determines a procedure and a communication mode for transmitting and receiving data between the internal system 1010 and the external system 1020 and converts a protocol used in the internal system 1010 into a protocol used in the external system 1020. As illustrated in FIG. 1, the protocol conversion processing unit 109 may access a protocol external definition 112. The protocol external definition 112 is information configured to define various correspondences associated with a protocol for performing conversion with the protocol of the external system 1020 similarly as the data model external definition 110 and will be described below by using FIG. 2.

A network access unit 116 takes charge of a communication between the internal system 1010 and the external system 1020.

In this configuration, the individual application processing units 102 that operate on the server 101 access data (for example, data stored in a database 104) on a server 103 included in the external system 1020 based on a standard or a method different from the standard or method used in the internal system 1010. In this case, first, the data model or interface is designated according to the type based on the standard or method of the internal system 1010 having the application processing units 102 therein. The internal system 1010 has a plurality of applications and designates the identification information 105, and as a result, the application may be used.

The middleware 106 that operates on a lower layer of the designated application is designated from the application processing unit 102 to perform conversion processing associated with various standards or methods for accessing the external system 1020. In the conversion processing, conversion processing is performed by three layers, such as conversion into the data model, conversion into the interface, and conversion into the protocol based on the standard or method of the external system 1020. In this case, correspondence or conversion definition between the data models for actually performing conversion between the data model of the internal system 1010 and the data model of the external model 1020 is externally defined to be maintained as the data model external definition 110, and the data model conversion processing unit 107 executes conversion of the data model by frequently referring to the external definition as necessary.

Similarly, even in regard to the interface conversion and the protocol conversion, the interface conversion processing unit 108 executes interface conversion processing by referring to the interface external definition 111, and the protocol conversion processing unit 109 executes protocol conversion processing by referring to the protocol external definition 112, respectively.

The protocol conversion processing unit 109 includes a combination processing unit 113 and a non-functioning requirement achievement processing portion 114. As described below, the protocol conversion processing unit 109 provides a means for automatically determining which processing module the protocol conversion is configured by, from requirements selected by an application developer, system configuration information defined by a system designer/developer, or system performance information verified on all such occasions.

The respective units of the server 101 is executed by software programs for implementing respective functions of the data model conversion processing unit 107, the interface conversion processing unit 108, and the protocol conversion processing unit 109. The software programs are configured by, for example, a module including the respective units and as actual hardware, a control unit such as a CPU reads and executes the software programs from a recording device such as an HDD to load the respective units onto a main storage device, and as a result, the respective units of the data model conversion processing unit 107, the interface conversion processing unit 108, and the protocol conversion processing unit 109 are created on the main storage device.

The software programs may be recorded and provided onto a computer readable recording media, such as a CD-ROM, a flexible disk (FD), a CD-R, a digital versatile disc (DVD), and the like as installable format or executable format files. The software programs are downloaded through a network to be provided or distributed.

Examples of externally defined items are illustrated in FIG. 2. FIG. 2 is a diagram illustrating examples of externally defined items (the data model external definition 110, the interface external definition 111, and the protocol external definition 112). In FIG. 2, the data model external definition 110, the interface external definition 111, and the protocol external definition 112 are illustrated as one table, but correspond to access the data model conversion processing unit 107, the interface conversion processing unit 108, and the protocol conversion processing unit 109, respectively as illustrated in FIG. 1.

As illustrated in FIG. 2, the data model external definition 110 stores a correspondence relationship between the data model used as the application processing unit 102 of the internal system 1010 and the data model used as the application of the external system 1020 or the database 104. The data model external definition 110 determines a format of data which data of a format determined according to a predetermined standard will be converted into, for each of data piece used as the application 102.

The interface external definition 111 stores a correspondence relationship between the interface used as the application processing unit 102 of the internal system 1010 and the interface used as the application of the external system 1020 or the database 104, similarly to the data model external definition 110. The interface external definition 111 determines a format of data which an interface of a format determined according to a predetermined standard will be converted into, for each interface used as the application 102.

In the protocol external definition 112, an interface procedure pattern, a communication protocol pattern, a communication definition, a system configuration/network pattern, network performance, and a non-functioning requirement are defined. Herein, the non-functioning requirement indicates a requirement other than respective functioning requirements of the interface procedure pattern, the communication protocol pattern, the communication definition, the system configuration/network pattern, and the network performance. The non-functioning requirement requires a definition for each of the individual applications (cannot be defined commonly to the applications) and defines applications' own requirement items, conditions, built-in functions, and additional definitions.

The interface procedure pattern is a procedure pattern at the time of executing the application determined for each interface used as the application and is set as any one of three patterns of ‘a request/replay pattern’, ‘a publish/subscribe pattern’, and ‘a unidirectional pattern’.

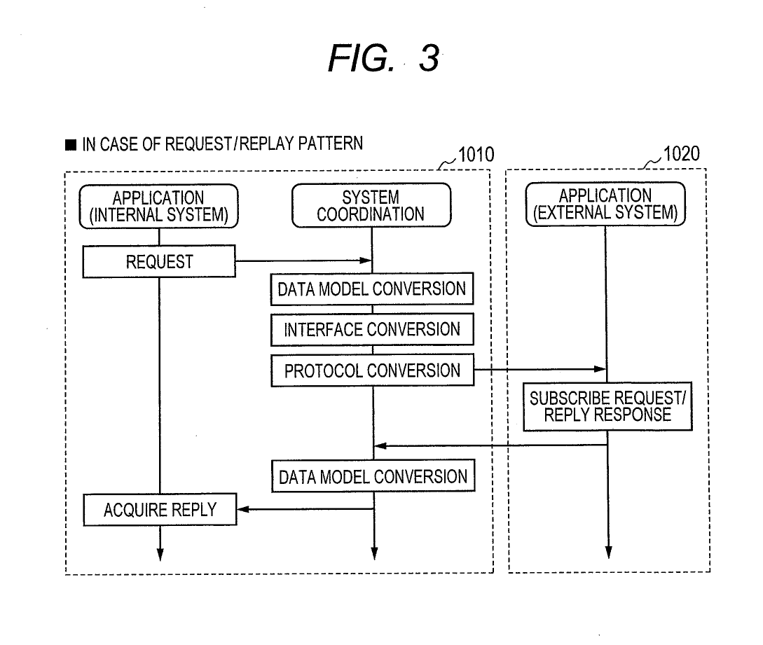

Herein, the ‘request/replay pattern’ is a pattern in which a requested system (for example, the external system 1020) make a response in synchronization with a request from a requesting system (for example, a request from the internal system 1010) that performs access, as illustrated in FIG. 3. In the case of the pattern, as the interface procedure pattern, conversion processing is performed in the order of ‘data model conversion’, ‘interface conversion’, ‘protocol conversion’, and ‘data model conversion’.

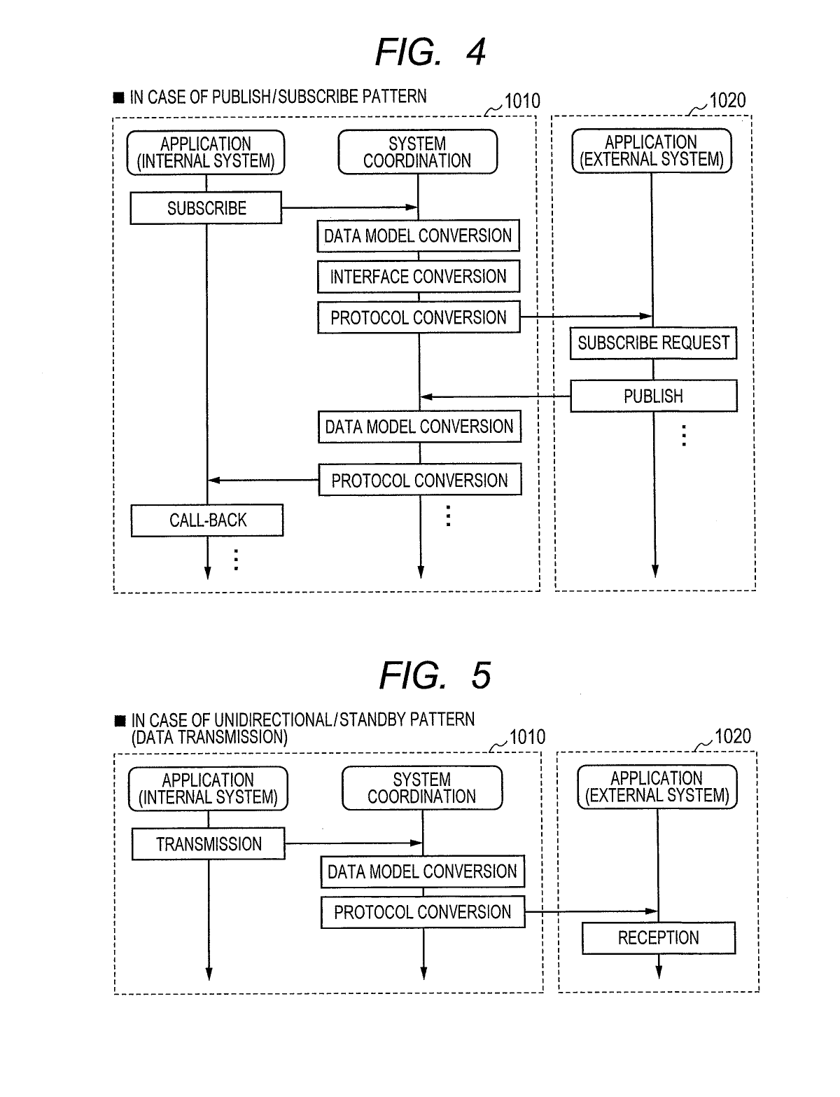

The ‘publish/subscribe pattern’ is a pattern in which the requesting system (for example, the internal system 1010) of the access registers a predetermined condition such as a response interval in the requested system (for example, the external system 1020), such that the requested system makes a response to the requesting system in a pattern according to the condition, as illustrated in FIG. 4. In the case of the pattern, conversion processing is performed in the order of ‘data model conversion’, ‘interface conversion’, ‘protocol conversion’, ‘data model conversion’, and ‘protocol conversion’.

The ‘unidirectional/standby pattern (data transmission)’ is a pattern in which data transmission from one system (for example, the internal system 1010) is achieved unilaterally regardless of a request from a destination system (for example, the external system 1020), as illustrated in FIG. 5. In the case of the pattern, conversion processing is performed in the order of ‘data model conversion’ and ‘protocol conversion’. As such, in the interface procedure pattern, it is determined in what order of procedures the application will be executed among the systems.

The communication protocol pattern is a pattern of the communication protocol used as each of the patterns of the ‘request/replay pattern’, the ‘publish/subscribe pattern’, and ‘the unidirectional pattern’ and is set as any one of the ‘request/replay pattern’, the ‘publish/subscribe pattern’, and ‘the unidirectional pattern’.

As the communication definition, various definitions are set, which are used as processing in the communication protocol by the communication protocol pattern and middleware that performs a communication by the communication protocol.

As the system configuration/network pattern, information on system configurations of the internal system 1010 and the external system 1020 and network patterns is set.

In the network performance, performance information regarding the communication, such as a communication speed assured in the network N is set.

As the non-functioning requirement (requirement item), items which may be set as the non-functioning requirement are set, such as performance other than the network performance, for example, performances of individual systems such as the internal system 1010 or the external system 1020, reliability of data, a security level (for example, security performance and security means) of the system, and the like.

As the non-functioning requirement (condition), a condition which should be achieved in association with the non-functioning requirement set the requirement item, for example, a condition regarding the requirement item, such as a lower limit of a system response, is set.

As the non-functioning requirement (built-in function), a definition of the built-in function which a developer of the internal system 1010 individually prepares, for example, a definition of the built-in function, such as a definition of a function which is protocol-converted, is set.

As the non-functioning requirement (additional definition), a requirement other than the non-functioning requirement, for example, a definition other than the non-functioning requirement required to execute the protocol conversion processing is set.

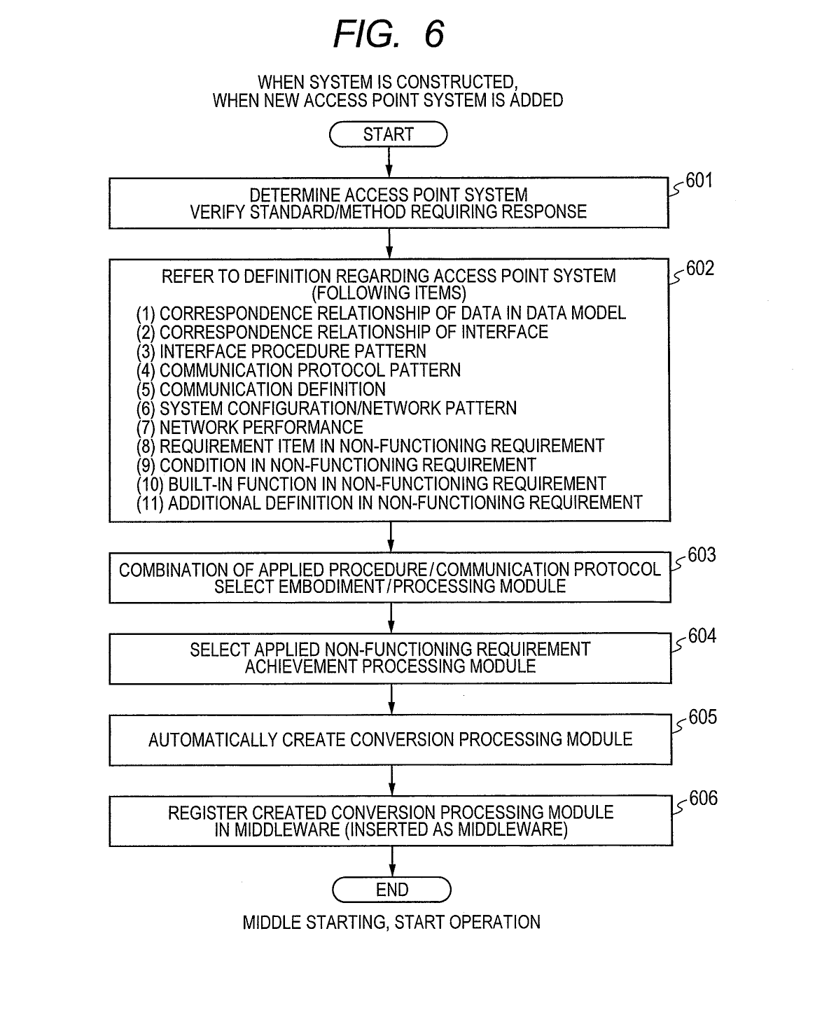

Subsequently, an example of a sequence at the time when the internal system 1010 accesses the external system 1020 to construct middleware for coordinating the systems with each other will be described. FIG. 6 is a flowchart illustrating a sequence of the intersystem coordination method.

As illustrated in FIG. 6, first, the server 101 receives designation of an external system as an access point and designation of a standard/method requiring correspondence, which are determined by a system constructer (step S601) and thereafter, receives setting of the externally defined items 1 to 11 illustrated in FIG. 2 for each external system 1020 as a connection/coordination target by the system constructer, refers to the definition information of the received items 1 to 11 in order to perform connection and coordination from the application processing unit 102 to the external system 1020. In addition, the data model conversion processing unit 107, the interface conversion processing unit 108, and the protocol conversion processing unit 109 execute required conversion processing, respectively (step S602).

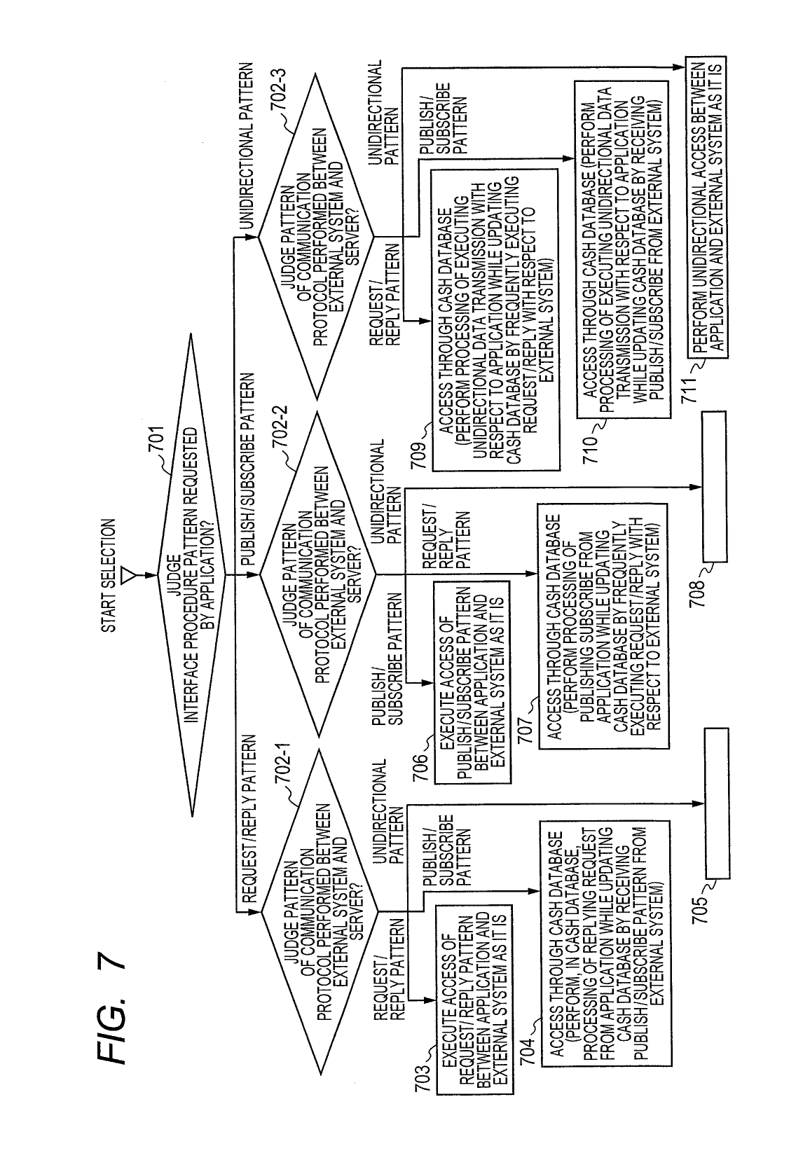

The protocol conversion processing unit 109 performs processing (combination processing) of selecting a combination embodiment/processing module of the procedure/communication protocol illustrated in FIG. 7, because the items 3 to 5 are definition information for selecting a processing embodiment for a combination of a procedure pattern and a used communication protocol (step S603), in the conversion processing of the protocol.

FIG. 7 is a flowchart illustrating a processing sequence of combination processing performed by a combination processing unit 113.

As illustrated in FIG. 7, first, the combination processing unit 113 judges which pattern the interface procedure pattern requested by the application processing unit 102 is among the ‘request/replay pattern’, the ‘publish/subscribe pattern’, and the ‘unidirectional pattern’ (step S701).

The combination processing unit 113 judges which the pattern of the communication protocol performed between the external system 1020 and the server 101 of the internal system 1010 is among the ‘request/replay pattern’, the ‘publish/subscribe pattern’, and the ‘unidirectional pattern,’ when judging that the interface procedure pattern requested by the application processing unit 102 is the ‘request/replay pattern,’ and selects a combination embodiment/processing module of the procedure/communication protocol to be adopted (step S702-1).

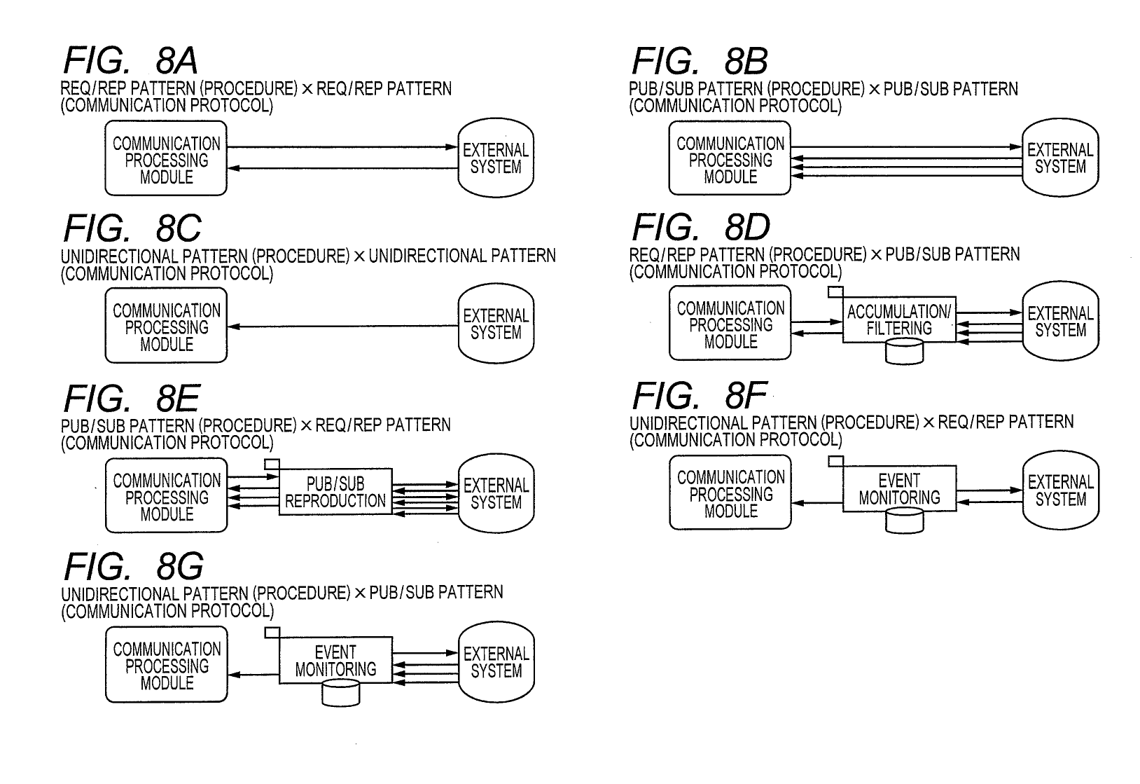

When it is judged that the pattern of the communication protocol is the ‘request/replay pattern’, in the case where the interface procedure pattern requested by the application processing unit 102 is the ‘request/replay pattern’ and the protocol of the communication actually performed between the external system 1020 and the server 101 of the internal system 1010 is the ‘request/replay pattern’, the selected module performs an access through the request/replay pattern between the application and the external system 1020 as it is (step S703 and FIG. 8A).

When it is judged that the pattern of the communication protocol is the ‘publish/subscribe pattern’, in the case where the interface procedure pattern requested by the application processing unit 102 is the ‘request/replay pattern’ and when the protocol of the communication actually performed between the external system 1020 and the server 101 of the internal system 1010 is the ‘publish/subscribe pattern’, the selected module prepares a cash database that receives the access from the application between the application and the external system 1020, updates the cash database receiving publish/subscribe pattern from the external system 1020, and performs processing of replying a request from the application in the cash database (step S704 and FIG. 8D).

In the case where the interface procedure pattern requested by the application processing unit 102 is the ‘request/replay pattern’ and the protocol of the communication actually performed between the external system 1020 and the server 101 of the internal system 1010 is the unidirectional pattern, a function corresponding to the protocol needs to be prepared in the external system 1020 in order to cope therewith, and as a result, the case is excepted herein (step S705).

The combination processing unit 113 judges which of the ‘publish/subscribe pattern’, the ‘request/reply pattern’, and the ‘unidirectional pattern’ the pattern of the communication protocol performed between the external system 1020 and the server 101 of the internal system 1010 is when judging that the interface procedure pattern requested by the application processing unit 102 is the ‘publish/subscribe pattern’ in step S701, and selects a combination embodiment/processing module of the procedure/communication protocol to be adopted (step S702-2).

In the case where the interface procedure pattern requested by the application processing unit 102 is the ‘publish/subscribe pattern’ and the protocol of the communication actually performed between the external system 1020 and the server 101 of the internal system 1010 is the ‘publish/subscribe pattern’, the selected module performs an access through the publish/subscribe pattern between the application and the external system 1020 as it is (step S706 and FIG. 8B).

Meanwhile, in the case where the interface procedure pattern requested by the application processing unit 102 is the ‘publish/subscribe pattern’ and the protocol of the communication actually performed between the external system 1020 and the server 101 of the internal system 1010 is the ‘request/reply pattern’, the selected module prepares the cash database that receives the access from the application between the application and the external system 1020, updates the cash database by frequently executing request/reply with respect to the external system 1020, and performs processing of publishing the subscription from the application in the cash database (step S707 and FIG. 8E).

In the case where the interface procedure pattern requested by the application processing unit 102 is the ‘publish/subscribe pattern’ and the protocol of the communication actually performed between the external system 1020 and the server 101 of the internal system 1010 is the unidirectional pattern, a function corresponding to the protocol needs to be prepared in the external system 1020 in order to cope therewith, and as a result, the case is excepted herein (step S708).

The combination processing unit 113 judges which of the ‘request/reply pattern’, the ‘publish/subscribe pattern’, and the ‘unidirectional pattern’ the pattern of the communication protocol performed between the external system 1020 and the server 101 of the internal system 1010 is when judging that the interface procedure pattern requested by the application processing unit 102 is the ‘unidirectional pattern’ in step S701, and selects a combination embodiment/processing module of the procedure/communication protocol to be adopted (step S702-3).

In the case where the interface procedure pattern requested by the application processing unit 102 is the ‘unidirectional pattern’ and the protocol of the communication actually performed between the external system 1020 and the server 101 of the internal system 1010 is the ‘request/reply pattern’, the selected module prepares a cash database that executes unidirectional data transmission to the application between the application and the external system 1020, updates the cash database by frequently executing request/reply with respect to the external system 1020, and performs processing of executing the unidirectional data transmission to the application in the cash database (step S709 and FIG. 8F).

Meanwhile, in the case where the interface procedure pattern requested by the application processing unit 102 is the ‘unidirectional pattern’ and the protocol of the communication actually performed between the external system 1020 and the server is the ‘publish/subscribe pattern’, the selected module prepares the cash database that executes unidirectional data transmission to the application between the application and the external system 1020, updates the cash database by receiving publish/subscribe from the external system 1020, and performs the processing of executing the unidirectional data transmission to the application in the cash database (step S710 and FIG. 8G).

In the case where the interface procedure pattern requested by the application processing unit 102 is the ‘unidirectional pattern’ and the protocol of the communication actually performed between the external system 1020 and the server 101 of the internal system 1010 is the ‘unidirectional pattern’, the selected module performs a unidirectional access between the application and the external system 1020 as it is (step S711 and FIG. 8C). Referring back to FIG. 6, processing after step S604 will be described.

The non-functioning requirement achievement processing portion 114 selects a built-in requirement achievement processing module adopted in connection with the external system 1020 from among non-functioning requirement achievement processing modules which are prepared in advance by the developer of the internal system 1010, in order to set the items 8 to 11 which is definition information for selecting a processing embodiment required to satisfy the non-functioning requirement (step S604).

In detail, the non-functioning requirement processing portion 114 refers to a performance requirement value (for example, a protocol conversion speed) required in individual applications or systems, which is set by the application developer or the system developer/manager in advance with respect to the non-functioning requirement associated with ‘performance’ among the non-functioning requirements (requirement items), selects a combination of a pattern of an access procedure and a used communication protocol and selects a processing embodiment therefor with respect to the external system 1020 which becomes a conversion target between the application and the internal system 1010.

The non-functioning requirement processing portion 114 acquires the performance of the internal system 1010 and the network from performance information measured/examined and defined in advance or information acquired by a frequent performance test. The performance test may be performed whenever connection/coordination with a new external system 1020 is required and may also be performed whenever connection/coordination with all external systems 1020 occurs.

The non-functioning requirement processing portion 114 selects the non-functioning requirement achievement processing module used in terms of whether the performance requirement values are satisfied, by comparing the performance requirement value with the performances of the internal system 1010 and the network and performing processing using the set communication protocol. In detail, the non-functioning requirement processing portion 114 creates replication of data on a server of an access requirement source in an access requirement destination when it is judged that the network performance is severely deficient, in order to achieve the performance requirement values, and selects the non-functioning requirement achievement processing module in which the application processing executes an access with respect to the replication. Alternatively, the non-functioning requirement processing portion 114 creates communication connection between the access requirement source and the access requirement destination and selects the non-functioning requirement achievement processing module that always ensures a communication under predetermined performance when it is judged that the network performance is theoretically sufficient but is performance which may be deficient due to a traffic situation and the like in order to achieve the performance requirement values. As such, the non-functioning requirement processing portion 114 may select a module suitable for the application 102 and execute the processing between the application 102 and the external system 1020 in an appropriate state.

The non-functioning requirement processing portion 114 refers to a reliability requirement value of data required in the individual applications or systems, which is set by the application developer or the system developer/manager with respect to a non-functioning requirement (requirement item) regarding ‘data reliability’, and selects a combination of a procedure pattern and a used communication protocol and selects a processing embodiment therefor, with respect to the external system 1020 as the conversion target between the application and the internal system 1010.

The non-functioning requirement processing portion 114 acquires the network pattern from predetermined information. A test for verifying reliability is performed as necessary. The reliability verification may be performed whenever connection/coordination with the new external system 1020 is required and may also be performed whenever connection/coordination with all the external systems 1020 occurs. The used non-functioning requirement achievement processing module is selected from quality comparison of the protocol and the network for the reliability requirement based on the set values and information thereof and necessity or nonnecessity of items which should be performed with respect to the communication protocol/network pattern. In detail, the non-functioning requirement processing portion 114 selects the non-functioning requirement achievement processing module that multiplexes the communication itself, in the case where the network performance is sufficient, even the application processing itself needs to be performed rapidly, and a reliability requirement is very high. Alternatively, the non-functioning requirement processing portion 114 selects the non-functioning requirement achievement processing module that requires retransmission of data as necessary, in the case where the network performance is not sufficient and the application processing itself is not performed rapidly, but the reliability requirement is very high. In the case where the target external system has a function to correspond to general data completeness check such as cyclic redundancy check (CRC), the non-functioning requirement achievement processing module that checks data completeness by using the function is selected.

The non-functioning requirement processing portion 114 selects a security requirement value required in the individual applications or systems, which is set by the application developer or the system developer/manager with respect the non-functioning requirement regarding ‘security’ among the non-functioning requirements (requirement items), selects the combination of the procedure pattern and the used communication protocol and a processing embodiment therefor, with respect to the external system 1020 as the conversion target between the application and the internal system 1010.

The non-functioning requirement processing portion 114 acquires a system configuration from predetermined information and acquires judgment of security means/performance of the external system 1020 from predefined information or information acquired by a frequent access test. The security test may be performed whenever connection/coordination with the new external system 1020 is required and may also be performed whenever connection/coordination with all the external systems 1020 occurs. Whether the security level required by the target external system 1020 is provided based on set values and information thereof is judged and whether or not required security processing is performed with respect to a communication protocol/system configuration is judged and thereafter, the used non-functioning requirement achievement processing module is selected. In detail, the non-functioning requirement processing portion 114 selects the non-functioning requirement achievement processing module that interrupts the access to the external system or partially filters the access such as allowing data to be acquired but not allowing data to be updated, in the case where it is judged that the target external system 1020 cannot cope with the required security requirement. Alternatively, when the external system 1020 capable of using a common authentication infrastructure is the target, the non-functioning requirement processing portion 114 selects the non-functioning requirement achievement processing module that authenticates the internal system 1010 and the external system 1020 by using the authentication infrastructure. When the external system 1020 is an external system 1020 corresponding to a predetermined encryption/complexation function, the non-functioning requirement processing portion 114 selects the non-functioning requirement achievement processing module that uses the encryption/complexation function.

The protocol conversion processing portion 113 creates middleware configured by the processing module selected by the non-functioning requirement processing portion 114 (step S605) and inserts the created middleware into the server 101 where the application of the internal system 1010 operates (step S606). In a distribution system constituted by, for example, a plurality of independent nodes that are interconnected through the network by inserting the middleware into the server 101, interconnection and intercoordination may be made between a system including one or more nodes and a system different from the system that perform data management and data access processing based on the same standard or method.

In more detail, in interconnection/coordination of the systems, three layers of the data model, the interface, and the protocol based on standards which different respective systems follow are converted into each other among different systems, the procedure pattern, an embodiment pattern of conversion with respect to a combination of the procedure pattern and the pattern of the used communication protocol, and a processing pattern for satisfying the non-functioning requirement are prepared in the protocol layer and used as common parts, while conversion processing in each layer for interconnection/coordination for each of relative systems that are interconnected/coordinated is implemented by a combination of the respective common parts and a combination of the common parts is designated as an external definition for each of the relative systems that are interconnected/coordinated. A program (processing module) to execute processing for interconnecting with a system of another standard/method and a processing module for satisfying the non-functioning requirement required by the application according to the system configuration are selected and configured according to the external definition in the layer of the protocol. Therefore, in development the application requiring connection/coordination with systems of other standards or methods, since the development of individual connection/coordination processing is separated from development of the application itself in development the application, the application developer need not directly consider the development of the individual connection/coordination processing and the development of the individual connection/coordination processing itself becomes easy, thereby improving productivity of the development of the system and application at large.

### Second Embodiment

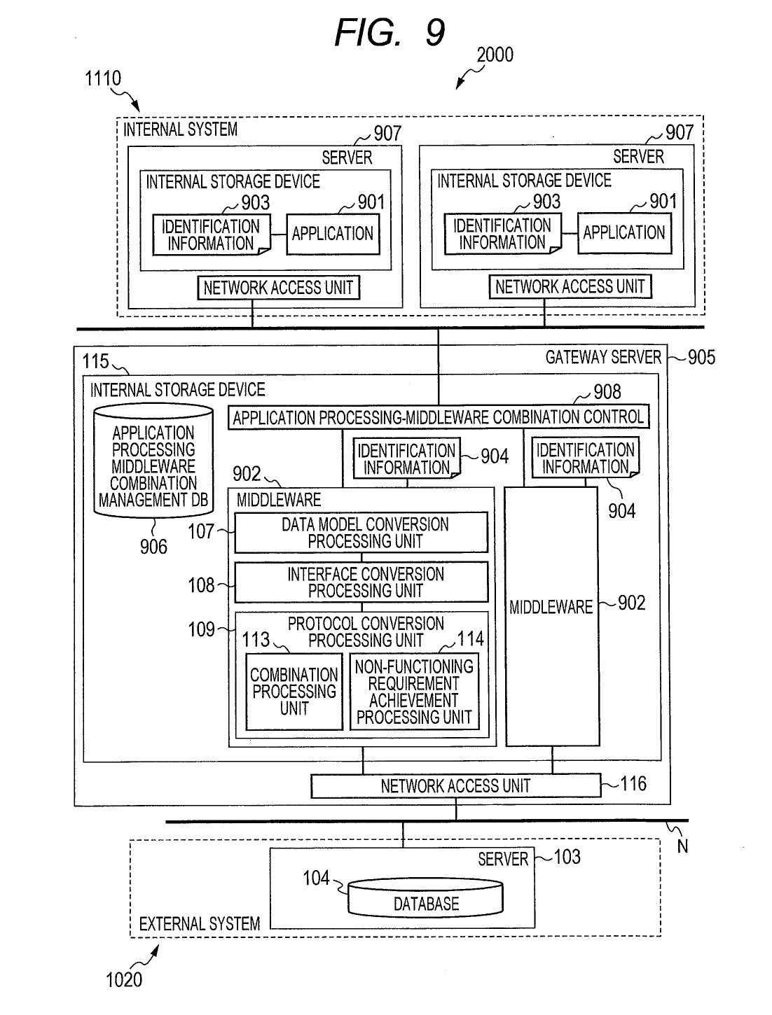

In the first embodiment, middleware performs processing required when the application processing unit accesses the external system, such that the application developer may select an appropriate combination of modules without considering conversion processing among the external systems, and exchange data between both parts. However, as illustrated in FIG. 9, in the second embodiment, processing required at the time of accessing the external system 1020 from individual application processing units 901 having a plurality of servers 907 is performed by middleware 902 stored in an internal storage device 115 of a gateway server 905 on a communication path.

In this case, in order to just identify the application processing units 901 of the respective servers 907, identification information 904 is previously set to correspond to middleware 902, such that a combination of identification information 903 of the individual application processing units 901 and the identification information 904 of the middleware is managed by an application processing/middleware combination/management database (DB) 906.

The middleware 902 is inserted onto not the server 907 where the application processing unit 901 operates but an additional server, for example, the gateway server 905 installed between the external system 1020 and the internal system 1010. When the application processing unit 901 accesses the external system 1020, middleware corresponding to the application is automatically selected to operate on the gateway server 905 by an application processing-middleware combination control unit 908, by comparing the identification information 904 of the middleware with the identification information 903 of the application processing unit 901 and referring to the application processing/middleware combination management DB 906 that manages the combination of the identification information 903 of the application processing unit 901 and the identification information 904 of the middleware 902.

By this configuration, like the case of the first embodiment, the access to the external system is implemented. According to the method, operations such as insertion of new middleware into the server 907 where the application processing unit 901 operates are never required and an existing system is just used to be connected/coordinated with the external system 1020. When a new application is installed in the system, the middleware 902 may be automatically created and used in each case by the method described in the first embodiment, by referring the identification information 903 of the application.

### Third Embodiment

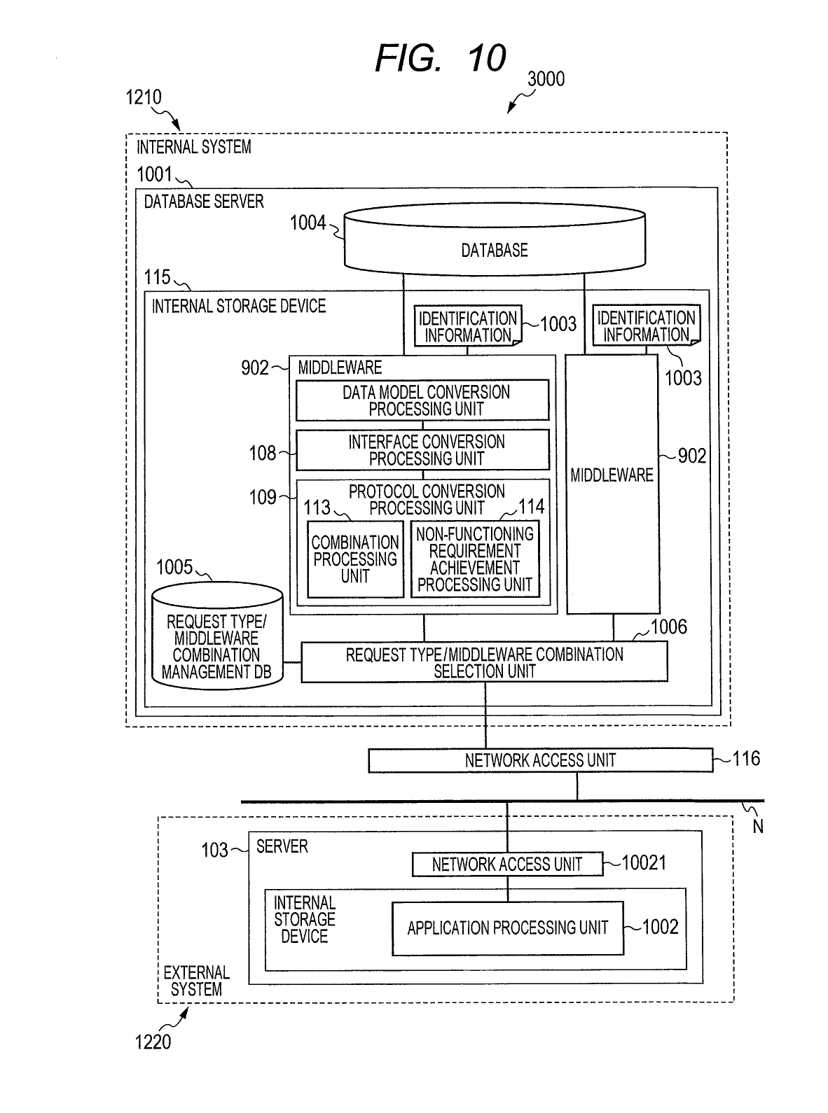

In the first embodiment, middleware performs processing required when the application processing unit 102 accesses the external system, such that the application developer may select an appropriate combination of modules without considering conversion processing among the external systems, to thereby exchange data between both parts. In addition, in the second embodiment, the function may be disposed on an additional server separated from the application processing itself that performs data access. However, the internal system may perform various processing according to a request from the external system in some cases. Therefore, as illustrated in FIG. 10, in the third embodiment, the middleware function is disposed on, for example, a database server 1001 where a database 1004 storing data used in the internal system 1210 is disposed. In this case, at the time of accessing the internal system 1210 from the external system 1220, the standard or method is selected and the middleware 902 is constructed according to the sequence described in the first embodiment, data model conversion, interface conversion, and protocol conversion are performed by the middleware 902, and thereafter, the database 1004 is accessed and processing requested by the external system 1220 is performed.

Since the identification information of the application processing unit 1002 on the external system 1220 cannot be generally acquired, the identification information of the application processing and the identification information of the middleware do not correspond to each other, but a request pattern/middleware combination selection unit 1006 extracts a request pattern requested from the external system 1220 from a protocol such as a request message, the request pattern and information corresponding to the identification information 1003 of the middleware 902 are managed by a request pattern/middleware combination management DB 1005, such that processing of automatically selecting corresponding middleware operates on the database server 1001 similarly as the second embodiment. As a result, the access may correspond to the access to the data of the internal system 1210 from the external system 1220.

Further, the present invention is not limited to the embodiments and various modifications can be made within the scope without departing from the spirit. In addition, various inventions may be formed by an appropriate combination of a plurality of constituting elements disclosed in the above-described embodiments. For example, some components may be deleted from all components presented in the embodiments. Furthermore, components according to different embodiments may be appropriately combined with each other.

What is claimed is:

1. An intersystem coordination apparatus, in a distribution system capable of accessing, from a system prepared based on a predetermined standard or method, the another system prepared based on a standard or method different from the system, the apparatus comprising:
a storage unit configured to store a pattern of a communication protocol between the system and the other system, a protocol definition in which system configurations of the system and the other system and network configurations correspond to each other, a non-functioning requirement which is a unique requirement of a predetermined application for the system to access the other system by using the predetermined application, and a plurality of modules for executing the application in accordance with the protocol definition and the non-functioning requirement;
an application processing unit configured to execute the predetermined application by accessing the other system; and
a combination processing unit configured to select a module required to execute processing by the application from the plurality of modules based on the non-functioning requirement and a requirement value required to perform processing between the system and the other system determined based on the communication protocol pattern, the system configuration, and the network configuration included in the protocol definition in accordance with a request from the predetermined application, in the case where the application processing unit receives an instruction to execute the predetermined application.

2. The intersystem coordination apparatus according to claim 1, wherein in the case where a procedure of processing for executing the request from the application of the system is a request/reply pattern and a pattern of the communication protocol is a publish/subscribe pattern, the combination processing unit updates a temporary storage database for receiving an access from the application which is installed between the other system and the system by receiving publish/subscribe received from the other system and simultaneously, inserts processing of replying a request from the application as the module.

3. The intersystem coordination apparatus according to claim 1, wherein in the case where a procedure of processing for executing the request from the application of the system is a publish/subscribe pattern and a pattern of the communication protocol is a request/reply pattern, the combination processing unit updates a temporary storage database for receiving an access from the application which is installed between the other system and the system by frequently executing request/reply with respect to the other system and simultaneously, inserts processing of publishing the subscription from the application as the module.

4. The intersystem coordination apparatus according claim 1, wherein in the case where the procedure of processing for executing the request from the application of the system is a unidirectional pattern and the pattern of the communication protocol is the request/reply pattern, the combination processing unit updates a temporary storage database for unidirectionally transmitting data which is installed between the other system and the system by frequently executing the request/reply with respect to the other system and simultaneously, inserts processing of unidirectionally transmitting data with respect to the application as the module.

5. The intersystem coordination apparatus according to claim 1, wherein in the case where the procedure of processing for executing the request from the application of the system is the unidirectional pattern and the pattern of the communication protocol is the publish/subscribe pattern, the combination processing unit updates a temporary storage database for unidirectionally transmitting data which is installed between the other system and the system by frequently executing the publish/subscribe with respect to the other system and simultaneously, inserts the processing of unidirectionally transmitting data with respect to the application as the module.

6. The intersystem coordination apparatus according to claim 1,
wherein the requirement value includes a performance requirement value for satisfying predetermined performance of the system or the other system, and
the combination processing unit selects a module required to execute the processing by the application from among the plurality of modules, based on the pattern of the communication protocol between the system and the other system, the combination of the system configurations and the network configurations of the system and the other system, and the performance requirement value.

7. The intersystem coordination apparatus according to claim 6, wherein when the network performance between the system and the other system deteriorates in order to satisfy the performance requirement value, the combination processing unit replicates the data used in the other system to a sever having the system where the application operates and inserts the processing of executing the processing into the application by accessing the replicated data as the module.

8. The intersystem coordination apparatus according claim 6, wherein when there is a possibility that the network performance between the system and the other system will be deficient due to a traffic situation in order to satisfy the performance requirement value, the combination processing unit creates communication connection between the system and the other system and inserts processing of ensuring a communication under predetermined performance to satisfy the performance requirement value as the module.

9. The intersystem coordination apparatus according to claim 1,
wherein the requirement value includes a reliability requirement value for satisfying predetermined reliability of data transmitted and received between the system and the other system, and
the combination processing unit selects a module required to execute the processing by the application from among the plurality of modules, based on the pattern of the communication protocol between the system and the other system, the combination of the system configurations and the network configurations of the system and the other system, and the reliability requirement value.

10. The intersystem coordination apparatus according to claim 9, wherein the combination processing unit inserts processing of multiplexing the communication in the network as the module, in the case where the network between the system and the other system is multiplexed and the reliability of the data is high.

11. The intersystem coordination apparatus according to claim 9, wherein the combination processing unit inserts processing of requesting retransmission of the data as the module, in the case where the network is not multiplexed, the communication protocol supports the retransmission of the data, and the reliability of the data is high.

12. The intersystem coordination apparatus according to claim 9, wherein in the case where the network is not multiplexed and the other system includes a check processing unit for checking completeness of the data, the combination processing unit inserts processing of allowing the check processing unit to check the data as the module.

13. The intersystem coordination apparatus according to claim 1,
wherein the requirement value includes a security requirement value for satisfying predetermined security levels of the system and the other system, and
the combination processing unit selects a module required to execute the processing by the application from among the plurality of modules, based on the pattern of the communication protocol between the system and the other system, the combination of the system configurations and the network configurations of the system and the other system, and the security requirement value.

14. The intersystem coordination apparatus according to claim 13, wherein in the case where it is judged that the other system does not satisfy the security requirement value, the combination processing unit interrupts an access to the other system or inserts processing of partially filtering the access as the module.

15. The intersystem coordination apparatus according to claim 13, wherein in the case where the other system is a system capable of using a common authentication infrastructure with the system, the combination processing unit inserts processing of performing authentication between the system and the other system based on the common authentication infrastructure.

16. The intersystem coordination apparatus according to claim 13, wherein in the case where the other system is a system corresponding to a predetermined encryption/complexation function, the combination processing unit inserts the processing of performing the authentication between the system and the other system as the module based on the predetermined encryption/complexation function.

17. The intersystem coordination apparatus according to claim 1, wherein the function performed by the combination processing unit is held on the server disposed on a communication path between the system and the other system.

18. The intersystem coordination apparatus according to claims 6, wherein every time the application is executed, the combination processing unit judges whether the other system satisfies a predetermined performance requirement value for satisfying predetermined performance of the system or the other system, a reliability requirement value for satisfying predetermined reliability of data transmitted and received between the system and the other system, or a security requirement value for satisfying predetermined security levels of the system and the other system, and selects the module.

19. The intersystem coordination apparatus according to claims 1, wherein the non-functioning requirement includes performances of individual systems, reliability of data, a security level of the system.
